(19) United States
(12) Patent Application Publication
(10) Pub. No.: US 2025/0037114 A1
(43) Pub. Date: Jan. 30, 2025

(54) SYSTEMS, METHODS, AND COMPUTER-READABLE MEDIA FOR STRUCTURED BLOCKCHAIN STREAMS

(71) Applicant: THINK THUNK MEDIA INC., Burlington (CA)

(72) Inventors: Peter William Humphries, Burlington (CA); Christian William Humphries, Burlington (CA); Mackenzie Parnham, Burlington (CA); Joel Young, Toronto (CA); Ehsan Ghasemi, Toronto (CA); Catalina Orrego, Etobicoke (CA); Vinay Malhotra, Pickering (CA); Nancy Pavici, Burlington (CA)

(21) Appl. No.: 18/357,492

(22) Filed: Jul. 24, 2023

(51) Int. Cl. G06Q 20/36; G06Q 20/38

(52) U.S. Cl. CPC G06Q 20/3672; G06Q 20/3825; G06Q 20/389

(57) ABSTRACT

Provided are systems, methods, and computer-readable media for structured blockchain streams. The method includes receiving, at a server from a first user device corresponding to a first user, a listing request for an item on the server, the listing request comprising: an item media identifier, a stream structure option, the stream structure option comprising a plurality of stream slots; a first wallet address identifier of the first user; and a smart contract identifier; generating, at the server, a voucher comprising the item attributes, the first wallet address identifier of the first user, account information of the first user, the stream structure option, item history and ownership history; storing, at the server, the generated voucher; and outputting, at the server, an item listing corresponding to the item voucher.

### FIELD

The described embodiments relate generally to a system and method for cryptocurrency transactions, and specifically to creating a structured cryptocurrency stream model for cryptocurrency transactions.

### BACKGROUND

Today's traditional online marketplaces are built on legacy ideals and technologies. These marketplaces are used because of their familiarity and because of the vast accumulation of users that they have amassed over the years. Historically, it has made sense to seek the largest pool of users if one is looking to sell an item, often regardless of the quality of users or the platform. For items on the secondary market that increase in value, such as collectables and antiques, it is assumed that these large marketplaces provide the best opportunity to profit by maximizing competition between buyers that are willing to pay more to acquire these items.

These marketplaces, however, are also susceptible to corruption and exploitation of their current controls. Malicious actors use the ease of entry in these markets and their lack of verification controls to exploit these marketplaces and scam individuals out of their items and/or money.

For example, users can buy items and make claims that the items were never received. The buyer can then receive a full refund and keep the items to resell on a later date or on another platform. Another common example originates from the seller side in which a user can list an item under a false account, receive money for an agreed upon transaction, and never ship the item thus pocketing the funds. There are a couple of reasons that this is easily performed on these sites. First, there is not a strong method to verify the user (though some sites are going down this path). By not placing some form of barrier to entry to join the site, it opens up the ability to exploit the site to create false accounts and fraudulent sales. Given the risk model of larger marketplaces, it is unlikely for them to place significant barriers to new users and additional transactions (profits). In addition, the inability to validate ownership of items is a prominent issue in today's marketplaces, thus reducing the ability to deter fraudulent listings. Users can grab images of items that they currently do not own and sell them without the intention of delivering said items.

The responsibility to decide the outcome of such incidents often lies solely with the application provider. This approach can lead to misjudgment of the events and the difficulty of presenting evidence for both parties helps to absolve these providers of fault.

These marketplaces also disadvantage users and creators who list items for sale. This is because some items can substantially increase in value in subsequent transactions, depriving the creator or first listed user from compensation as the item grows in popularity. Investment markets like the secondary collectables market suffer from market challenges (seller market timing, seller risk mitigation challenges, market stagnation, various types of fraud, etc.).

The recent introduction of blockchain technologies means that there is no reason that fraudulent activities should not be scrutinized; nor why these important decisions should not be placed into the hands of the individuals who are impacted the most, i.e. the users.

Blockchain refers to a framework that supports a trusted ledger that is stored, maintained, and updated in a distributed manner in a peer-to-peer network. For example, in a cryptocurrency application, such as Bitcoin or Ethereum, Ripple, Dash, Litecoin, Doge-coin, zCash, Tether, Bitcoin Cash, Cardano, Setllar, EOS, NEO, NEM, Bitshares, Decred, Augur, Komodo, PIVX, Waves, Steem, Monero, Golem, Stratis, Bytecoin, Ardor, or in digital currency exchanges, such as Coinbase, Kraken, CEX.IO, Shapeshift, Poloniex, Bitstamp, Coinmama, Bisq, LocalBitcoins, Gemini and others where the distributed ledger represents each transaction and where units of the cryptocurrency are transferred between entities.

Blockchain technologies are more generally referred to as distributed electronic ledgers. They are electronic ledgers where different parts of each ledger are stored in different systems, often but not necessarily owned by different parties. A distributed ledger may be partitioned by record, by field, or a combination of the two. A blockchain may be a transactional or distributed ledger trusted by digital signatures that certify the content and/or sequence within the ledger. Individual records may also be certified through digital signatures by other parties. Electronic ledgers may be implemented to include or interface with smart contracts in the form of computing engines. A smart contract may be an executable program with a set of business logic that governs valid entries in an electronic ledger. In some embodiments, a smart contract may be registered or distributed within a blockchain, multi-chain or any type of electronic ledger, so that participants can validate or execute steps defined in the contract.

Another prominent feature of blockchain technologies is smart contracts which can provide flexibility for how transactions are processed. NFTs, for example, are generally minted using a smart contract. These smart contracts can be associated with the transactions of the NFT and provide the ability to apply self-executing actions to these subsequent transactions.

When one talks about Non-Fungible Tokens (also known as ERC-721 tokens), they are describing digital assets that are unique in nature and ownership of these assets is verified and tracked by embedding them on some form of the blockchain network. This validation by members of the blockchain allows for the asset to be trusted and securely transacted as each of these transactions are verified by the blockchain, and ownership of the asset is tracked. Today, this function is being used for digital items including art and collectables, but its application to items that are more tangible in nature will gradually increase as more familiarity with the concepts around cryptocurrency and blockchain technologies take place. It should be expected that many of the transactions we are accustomed to today will soon be migrated to blockchains in order to leverage its benefits as the technology becomes rapidly more familiar to the public. Thus far, many individuals have seized the opportunity to create NFTs due to the perceived rarity one can apply to an item. Many early creators have benefited by the exclusivity of items alone dictating their value given the novelty of the technology at the time.

These early creators however, have suffered from the above noted limitations, including where they have created NFTs for assets that have substantially increased in value in subsequent transactions after the initial transaction.

### SUMMARY

Provided herein are systems, methods, and computer-readable media for providing an item listing for items having structured blockchain streams. The blockchain streams provide for users listing collectables or other physical items on a marketplace, in addition to users listing digital assets for sale. The present blockchain stream embodiments open up possibilities for users to be strategic about the reward or unrealized profit for an item they are listing, and permits the mitigation of losses based on future price increases in the asset listed in the marketplace. The streams assign structures based on but not limited to a number of identified factors, such as market timing considerations, prospecting opinions, seller risk appetite, etc.

The stream structure herein includes “slots”. The behavior of the slots within a stream structure, and what benefits the slots give in a variety of situations and outcomes, has been identified by the inventors for improving the transactions involving blockchain and NFT technologies, along with the blockchain and NFT technologies themselves.

In a first aspect there is provided a computer-implemented method for providing an item listing platform, the method comprising: receiving, at a server from a first user device corresponding to a first user, a listing request for an item on the server, the listing request comprising: an item media identifier, a stream structure option, the stream structure option comprising a plurality of stream slots; a first wallet address identifier of the first user; and a smart contract identifier; generating, at the server, a voucher comprising the item attributes, the first wallet address identifier of the first user, account information of the first user, the stream structure option, item history and ownership history; storing, at the server, the generated voucher; and outputting, at the server, an item listing corresponding to the item voucher.

In one or more embodiments, the method may further include: receiving, at the server from a second user device corresponding to a second user, a purchase request, the purchase request comprising a second wallet address identifier associated with the second user; creating, at the server, a token associated with the item, the token comprising the item and the voucher; executing a smart contract associated with the smart contract identifier based on the first wallet identifier, the second wallet identifier, and the voucher; generating a stream structure corresponding to the stream structure option; adding a first stream entry to the stream structure, the first stream entry comprising a first allocation and the first wallet address identifier of the first user.

In one or more embodiments, the method may further include: receiving, at the server from a third user device corresponding to a third user, a purchase request, the purchase request comprising a third wallet address identifier associated with the third user; updating, at the server, the token associated with the item; executing a smart contract associated with the smart contract identifier based on the first wallet identifier, the second wallet identifier, the third wallet identifier, and the voucher; adding a second stream entry to the stream structure, the second stream entry comprising a second allocation and the second wallet address identifier of the second user; and executing the stream structure corresponding to the stream structure option, wherein the first user occupies a first slot of the plurality of stream slots.

In one or more embodiments, the method may further include: receiving, at the server from a fourth user device corresponding to a fourth user, a purchase request, the purchase request comprising a fourth wallet address identifier associated with the fourth user; updating, at the server, the token associated with the item; executing a smart contract associated with the smart contract identifier based on the first wallet identifier, the second wallet identifier, the third wallet identifier, the fourth wallet identifier, and the voucher; adding a third stream entry to the stream structure, the third stream entry comprising a third allocation and the third wallet address identifier of the third user; and executing the stream structure corresponding to the stream structure option, wherein the first user occupies a first slot of the plurality of stream slots, and the second user occupies a second slot of the plurality of stream slots.

In one or more embodiments, the executing the smart contract associated with the smart contract identifier may be based on at least two wallet identifiers selected from the list of the first wallet identifier, the second wallet identifier, the third wallet identifier, and the fourth wallet identifier; and the voucher generates an entry on a blockchain, wherein the entry on the blockchain may be a blockchain entry.

In one or more embodiments, the blockchain may be one selected from Etherium, Bitcoin, Tether, Binance Coin, USD Coin, XRP, Terra, Solana, Cardano, and Avalanche.

In one or more embodiments, the token associated with the item may be updated to reflect the purchase request.

In one or more embodiments, the number of stream structure slots may be finite.

In one or more embodiments, a user identifier corresponding to the first user may be stored in one of the slots of the plurality of stream structure slots.

In one or more embodiments, subsequent users may be added to the stream structure using a first in first out structure.

In one or more embodiments, the voucher may further comprise a verified identifier, wherein the verified identifier may be a characteristic to accurately identify the item as original, optionally a serial number, a third party validation, a certificate of authenticity and any combination thereof.

In one or more embodiments, the executing the smart contract may comprise a withdrawal request from the first wallet identifier, the second wallet identifier or the third wallet identifier.

In one or more embodiments, the method may further include: the server sending a verification request to the second user; the second user, in response to the verification request, sends a verification response comprising confirmation information to the server; the server outputs a verification result, in response to the verification response, based on the item attribute and verification response; wherein the verification result compares the item attribute to the verification response.

In one or more embodiments, subsequent to the verification result the server may trigger a payment request from the second wallet identifier to the first wallet identifier.

In one or more embodiments, the payment may be held by the server until the withdrawal request is received at the server, from a user.

In one or more embodiments, the stream structure option may comprise an unlimited number of stream slots.

In one or more embodiments, the stream structure option may comprise four stream slots.

In one or more embodiments, the four stream slots may be configured to generate payments equally amongst users.

In one or more embodiments, the four stream slots may be configured to generate payments unequally amongst users.

In one or more embodiments, the method may further include: generating, at the server, a store, the store comprising a store smart contract.

In one or more embodiments, the method may further include: a first user identifier, members of the store, wherein the members of the store have a user-specific wallet identifier; an item listing identifier; and parameters of the stream structure option.

In one or more embodiments, the finite stream structure slots may be five slots.

In one or more embodiments, the token may be generated upon completion of the purchase request, the method further including: executing the smart contract, wherein the smart contract retrieves, from the server, the information contained in the store smart contract; minting the token; assigning the token to a purchasing user, wherein the ownership is assigned to the second wallet identifier of the second user.

In one or more embodiments, the generating the stream structure corresponding to the stream structure option may trigger the smart contract to add a new user to the stream structure slots.

In one or more embodiments, the payment may be allocated based on the parameters of the store smart contract.

In one or more embodiments, the parameters of the store smart contract may provide for payment to a plurality of wallet identifiers of a plurality of users.

In one or more embodiments, the method may further include: adding the first stream entry to the stream structure, the first stream entry comprising the first allocation and the first wallet address identifier of the first user.

In one or more embodiments, the method may further include: adding the second stream entry to the stream structure, the second stream entry comprising the second allocation and the second wallet address identifier of the first user.

In one or more embodiments, a subsequent buyer may be added to the plurality of stream slots following execution of the smart contract.

In one or more embodiments, the execution of the smart contract may further include a change of ownership recorded on the token.

In one or more embodiments, the payment may be held in proxy until a release of funds condition is satisfied.

In one or more embodiments, the release of funds condition may include at least one of physical transfer of the item, completion of the verification request and the withdrawal request is received at the server.

In a second aspect, there is provided a computer-implemented system for providing an item listing platform, comprising: a memory; a network device; a processor in communication with the memory and the network device, the processor configured to perform any of the methods described herein.

In a third aspect, there is provided a computer-readable media for providing an item listing platform, the computer-readable media having instructions for operating a processor to perform any of the methods described herein.

### BRIEF DESCRIPTION OF THE DRAWINGS

A preferred embodiment of the present invention will now be described in detail with reference to the drawings, in which:

FIG. 1 is a system diagram showing an item management platform for implementing structured cryptocurrency royalties in accordance with one or more embodiments;

FIG. 2 is a system diagram in accordance with one or more embodiments;

FIG. 3 is a device diagram in accordance with one or more embodiments;

FIG. 4 is a method diagram in accordance with one or more embodiments;

FIG. 5 is a user interface diagram in accordance with one or more embodiments;

FIG. 6 is a user interface diagram in accordance with one or more embodiments; and

FIG. 7 is a stream structure diagram in accordance with one or more embodiments.

### DESCRIPTION OF EXEMPLARY EMBODIMENTS

Various apparatuses or methods will be described below to provide an example of the claimed subject matter. No example described below limits any claimed subject matter and any claimed subject matter may cover methods or apparatuses that differ from those described below. The claimed subject matter is not limited to apparatuses or methods having all of the features of any one apparatus or methods described below or to features common to multiple or all of the apparatuses or methods described below. It is possible that an apparatus or methods described below is not an example that is recited in any claimed subject matter. Any subject matter disclosed in an apparatus or methods described below that is not claimed in this document may be the subject matter of another protective instrument, for example, a continuing patent application, and the applicants, inventors or owners do not intend to abandon, disclaim or dedicate to the public any such invention by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It should also be noted that the terms “coupled”, or “coupling” as used herein can have several different meanings depending on the context in which these terms are used. For example, the terms “coupled”, or “coupling” can have a mechanical, electrical or communicative connotation. For example, as used herein, the terms “coupled”, or “coupling” can indicate that two elements or devices can be directly connected to one another or connected to one another through one or more intermediate elements or devices via an electrical element, electrical signal or a mechanical element depending on the particular context. Furthermore, the term “communicative coupling” indicates that an element or device can electrically, optically, or wirelessly send data to another element or device as well as receive data from another element or device.

It should also be noted that, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

It should be noted that terms of degree such as “substantially”, “about” and “approximately” as used herein mean a reasonable amount of deviation of the modified term such that the end result is not significantly changed. These terms of degree may also be construed as including a deviation of the modified term if this deviation would not negate the meaning of the term it modifies.

Furthermore, the recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed.

Some elements herein may be identified by a part number, which is composed of a base number followed by an alphabetical or subscript-numerical suffix (e.g., 112a, or 112₁). Multiple elements herein may be identified by part numbers that share a base number in common and that differ by their suffixes (e.g., 112₁, 112₂, and 112₃). All elements with a common base number may be referred to collectively or generically using the base number without a suffix (e.g., 112).

The example systems and methods described herein may be implemented in hardware or software, or a combination of both. In some cases, the examples described herein may be implemented, at least in part, by using one or more computer programs, executing on one or more programmable devices comprising at least one processing element, a data storage element (including volatile and non-volatile memory and/or storage elements), and at least one communication interface. These devices may also have at least one input device (e.g., a keyboard, a mouse, a touchscreen, and the like), and at least one output device (e.g. a display screen, a printer, a wireless radio, and the like) depending on the nature of the device. For example, and without limitation, the programmable devices (referred to below as computing devices) may be a server, network appliance, embedded device, computer expansion module, personal computer, laptop, personal data assistant, cellular telephone, smart-phone device, tablet computer, wireless device or any other computing device capable of being configured to carry out the methods described herein.

In some examples, the communication interface may be a network communication interface. In examples in which elements are combined, the communication interface may be a software communication interface, such as those for inter-process communication (IPC). In still other examples, there may be a combination of communication interfaces implemented as hardware, software, and a combination thereof.

Program code may be applied to input data to perform the functions described herein and to generate output information. The output information is applied to one or more output devices, in known fashion.

Each program may be implemented in a high-level procedural, declarative, functional or object-oriented programming and/or scripting language, or both, to communicate with a computer system. However, the programs may be implemented in assembly or machine language, if desired. In any case, the language may be a compiled or interpreted language. Each such computer program may be stored on a storage media or a device (e.g., ROM, magnetic disk, optical disc) readable by a general or special purpose programmable computer, for configuring and operating the computer when the storage media or device is read by the computer to perform the procedures described herein. Examples of the system may also be considered to be implemented as a non-transitory computer-readable storage medium, configured with a computer program, where the storage medium so configured causes a computer to operate in a specific and predefined manner to perform the functions described herein.

Furthermore, the example system, processes and methods are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloads, magnetic and electronic storage media, digital and analog signals, and the like. The computer useable instructions may also be in various forms, including compiled and non-compiled code.

Various examples of systems, methods and computer programs products are described herein. Modifications and variations may be made to these examples without departing from the scope of the invention, which is limited only by the appended claims. Also, in the various user interfaces illustrated in the figures, it will be understood that the illustrated user interface text and controls are provided as examples only and are not meant to be limiting. Other suitable user interface elements may be used with alternative implementations of the systems and methods described herein.

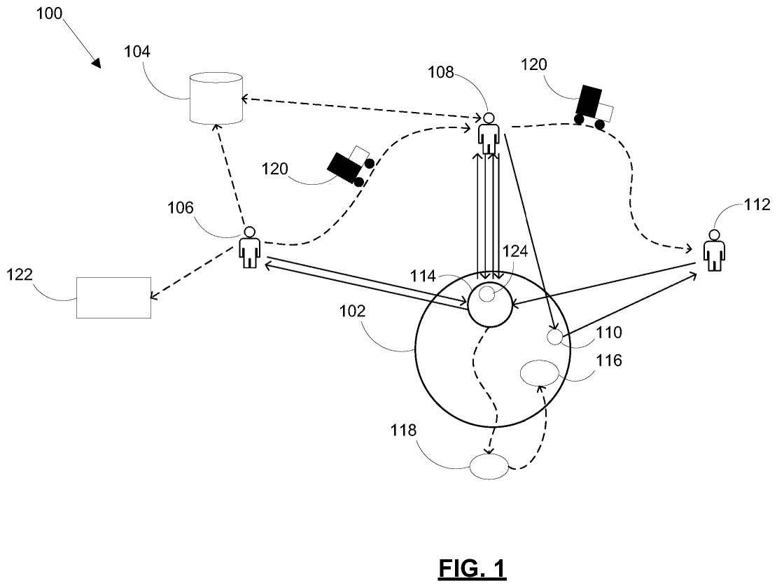

Reference is first made to FIG. 1, showing a system diagram 100 including an item management platform 102 for generating structured blockchain streams in accordance with one or more embodiments. The system diagram 100 further includes a server 104, a first user 106, a second user 108, a third user 112, a digital asset sharing system 122 for example the InterPlanetary File System (IPFS), and an item 120 to be listed by the first user 106 on the item management platform 102.

The item management platform 102, may further comprise a non-fungible token (NFT) system 110, a store 114, and a treasury 116.

The item management platform 102, as described herein, may be a marketplace including a web-based listing of items available for sale. The item management platform 102 may include items that correspond to physical items for sale, or alternatively, may include items that correspond to digital assets that may be minted and sold. The item management platform 102 may be a secondary market, where physical items are re-sold.

The item management platform 102 may be a marketplace where users (such as users 106, 108, 112) may add items as well as track item listings, sell existing items, collect payment from items that have sold, and earn income. Users may have the ability to provide images, attributes, or other digital assets of their items to the item management platform 102. These digital assets may be stored, for example, at digital asset sharing system 122. These digital assets may be viewed by the listing user, or by another user by accessing the listing user's profile. The item management platform 102 may enable the listing user to share with other users of the platform, for example, by sharing a URL to the listing on a social media platform such as Twitter®, Facebook®, or Mastodon®.

The item management platform 102 may include one or more stores 114 which may provide item listings. The one or more stores 114 may each be associated with a particular creator user, or alternatively, may display items for more than a single user. Each of the one or more stores 114 may be associated with a store smart contract on a blockchain, for example, the Ethereum blockchain.

When an item 120 is first added to the store 114, it is assigned a stream structure as described herein. This stream structure may allow benefits to the original owner (or listing user) who listed the item and may provide an incentive to future purchasers of the item. The listing of the item 120 results in the creation of a voucher at server 104. The ability to assign such a stream structure to an item 120 allows for a user to benefit from future revenue accrued by the resale of the item. When sold on the store 114, a record corresponding to the item 120 is placed on a blockchain based upon the information in the voucher at server 104. This may be performed by minting an NFT 124. Placing the item on the blockchain may provide transparency and may operate to authenticate the item 120 when presented to the other users. Fraudulent activity or malicious actors may be flagged and penalized by the members of the community instead of by the platform itself.

The item management platform 102 may be governed by the community of users and follows a strict set of rules that have been created to help build the most trusted platform for buyers, sellers and collectors. In addition to the ability to earn passive income on previously owned items, monetary incentives may be provided to users who help contribute to the growth of the platform 102 either through transactional contributions or governance of the platform.

The item management platform 102 may read and write transactions with a blockchain. This can include an associated smart contract on the blockchain and may include creating an NFT 124. Ownership of an item 120 may be tracked, and owners of the items (such as item 120) can be viewed on the platform 102. This form of digital ownership may allow users who have sold an item to remain connected to the item and part of the lifecycle of that item on the platform 102. This may reward users via the unique stream structure associated with that item. Items 120 may have attributes appended to their smart contract to ensure that true transparency of changes can be viewed by all within the community.

An item listing is created, and a voucher is stored at server 104 when the item is listed. Subsequently, the NFT 124 may be created based on the voucher at the server 104 when the item is first sold to another user on the item management platform which associates the item listing with the NFT 124. The NFT 124 may include the data associated with the item, including the item information contained in a voucher. The NFT 124 may be associated with the item listing when minted. Minting refers to the recording or adding of the NFT 124 to the blockchain at the time of item association, or when the item is first sold after creation, by the process of lazy minting.

The listing user 106 may provide their digital wallet (such as a cryptocurrency wallet or a noncustodial wallet) to store 114 when they create an account or when they create a listing for an item 120. When the NFT 124 is created for an item (either when the listing is created, or in the case of lazy minting, when the listing is first sold), the creator may use the digital wallet, and select a marketplace, a blockchain provider, or a project (e.g., Website for subject matter/NFT collections). For example, if the digital wallet is a cryptocurrency wallet, it enables payment with an appropriate crypto/digital currency for the minting process, listing fees, other fees, and for the purchase of an NFT 124 associated with an item, to be purchased after minting. A smart contract governs the rights associated with the item, and are provided in the NFT contract, commonly referred to as the “metadata” of the NFT. Rights in subject matter may include ownership of the item or ownership of the NFT itself, as a few non-limiting examples. The creator of the subject matter of the listing (i.e., item listing) and/or the NFT may determine what rights (i.e., the NFT contract) in the item, if any, come with NFT ownership at the time the NFT is minted.

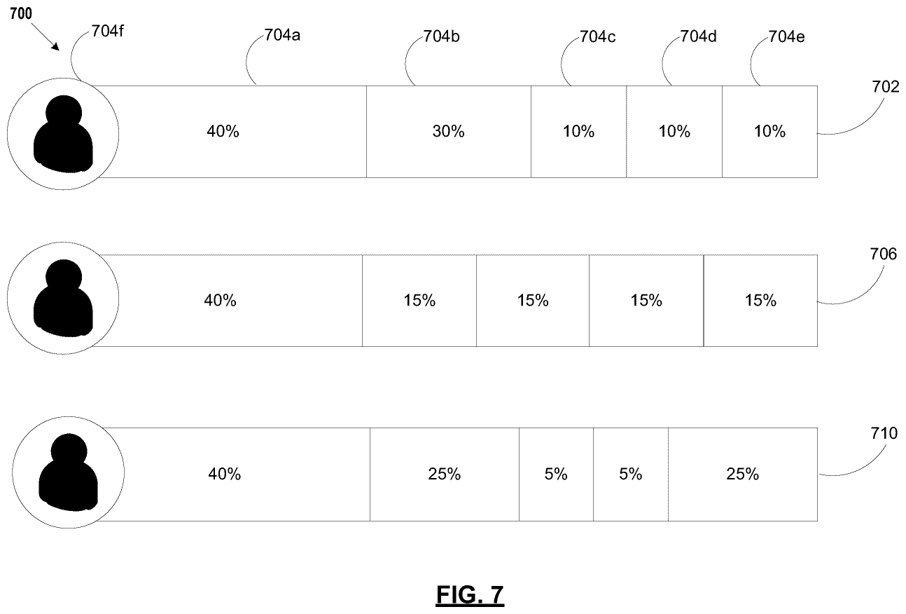

The voucher is created upon the listing of an item on the item management platform 102. The voucher is stored at the server 104 until the first sale occurs. The voucher may contain a reference to a smart contract on the blockchain. The smart contract may include instructions on the parameters of the sale, including for example, the stream structure options, described in more detail in FIG. 7. Upon sale, the NFT 124 is minted and may contain the voucher and the smart contract.

A store 114 may be deployed by a first user 106 on the item management platform 102. The store may contain a store smart contract that defines the parameters of the store. The parameters of the store may include, for example, the name of the store, the parameters and preferences, ability to list an item, and members of the store.

A treasury 116 may hold the funds of item sales from platform 102 until a withdrawal request from a user is received. A user may initiate a withdrawal request to receive the proceeds of a sale, sales or royalties generated from stream structures. Upon initiating a withdrawal request the user may pay transaction fees such as gas fees. The treasury 116 may be a shared account of the platform that may hold cryptocurrency tokens until a user requests a withdrawal. This may be performed in order to reduce gas fees.

The IPFS 122 may receive and store the uploaded images and other pieces of information from the first user 106 when the item is listed. The IPFS 122 may be referenced in the smart contract, item profile or any other place necessary to retrieve the information. The IPFS 122 may provide a digital asset URL when the NFT 124 is minted.

The item 120 may include being transferred or shipped from a first user 106 to a second user 108 upon the purchase of the item 120 in store 114. The shipment of the item 120 may trigger a verification request. At the time the second user 108 purchases the item 120 from the first user 106, the stream structure may be generated and the wallet information of the first user 106 may be added. This may be performed by the smart contract when the associated NFT 124 corresponding to item 120 is minted.

Subsequently, when the item 120 is purchased by third user 112 from second user 108, it may be shipped from the second user 108 to the third user 112. At the time the third user 112 purchases the item 120 from the second user 108, the second user 108 may be added to the stream structure associated with the NFT 124 corresponding to the item 120.

The methods of adding users to a stream structure are described in further detail below.

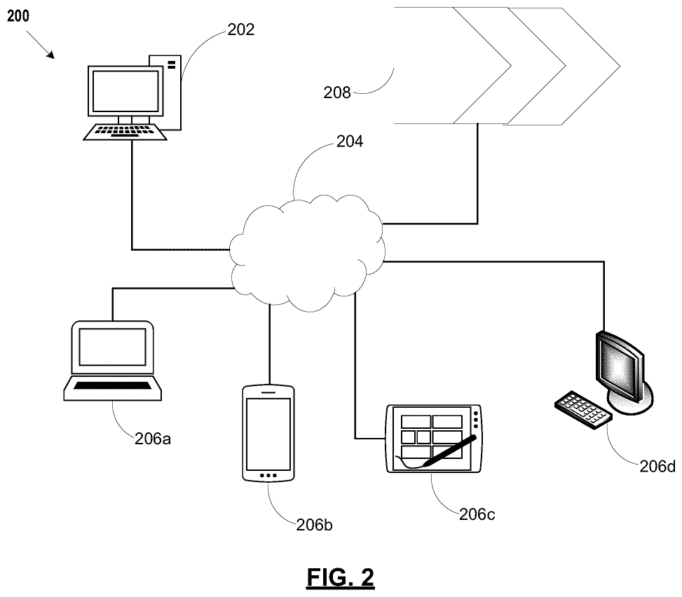

Reference is next made to FIG. 2, which illustrates a system diagram of an item management platform 200. The item management platform 200 includes a server 202 (for example, server 104 in FIG. 1), a network 204, and a plurality of user computing devices 206.

Users (not shown) may each operate computing devices 206a-206d in order to participate in the item management platform. The users may be a listing user (such as the first user 106—See e.g., FIG. 1) and/or purchasing user (see e.g. second user 108—See e.g. FIG. 2). The users may input the requested information to list an item, purchase an item, and participate in the item management platform 200.

As shown, the item management platform 200 includes a network 204 for connecting the server 202, and the plurality of user computing devices 206.

Network 204 may be any network or network components capable of carrying data including the Internet, Ethernet, fiber optics, satellite, mobile, wireless (e.g. Wi-Fi, WiMAX), SS7 signaling network, fixed line, local area network (LAN), wide area network (WANO), a direct point-to-point connection, mobile data networks (e.g., Universal Mobile Telecommunications System (UMTS), 3GPP Long-Term Evolution Advanced (LTE Advanced), Worldwide Interoperability for Microwave Access (WiMAX), etc.) and others, including any combination of these.

A user computing device 206 may be any two-way communication device with capabilities to communicate with other devices. A user computing device 206 may be any mobile device such as mobile devices running the Google® Android® operating system or Apple® iOS® operating system. The computing device 206 may be a personal computer, a workstation, a server, a portable computer, a mobile phone, a laptop wireless coupled to an access point (e.g., a wireless router, a cellular communications tower, etc.), a wirelessly enabled personal data assistant (PDA) or a smart phone, a terminal, a tablet computer, a game console over a wired or wireless connection, a WAP phone, or a combination of these.

Each user computing device 206 may include and execute a user application, such as an item management application, to receive notifications. The user application may be a web application provided by server 202 of item management platform 200, or it may be an application installed on the user computing device 206, for example, via an app store such as Google® Play® or the Apple® App Store®.

By way of an example, the item management platform 200 illustrates four user computing devices 206, namely a first user computing device 206a, a second user computing device 206b, a third user computing device 206c and a fourth user computing device 206d. The item management platform 200 can include any number of user computing devices 206.

As shown, the user computing devices 206 are configured to communicate with server 202 using a network interface 204. For example, server 202 may provide a web application or Application Programming Interface (API) endpoint for an application running on user devices 206.

One or more blockchain systems 208 may be accessible by server 202 over network 204. This may include the Ethereum blockchain. These one or more blockchain systems may receive one or more requests from server 202 in order to call the smart contracts stored on the blockchain. The server 202 may itself be a node of the blockchain and may submit transactions using the local node. The smart contracts may include a contract to create an NFT, assign a stream structure to an NFT, transfer ownership of an NFT, etc.

The server 202 is any networked computing device or system, including a processor and a memory, and is capable of communication with a network, such as network interface 204. The server 202 may include one or more systems or devices that are communicably coupled to each other.

The server 202 manages the accounts of various users of the item management platform 200 and facilitates the listing, selling and purchasing between users. For example, the server 202 may allow users to create user accounts, add user profile information associated with a user account, upload images, etc. The plurality of user accounts, the plurality of user profile information, the plurality of uploaded images, and the plurality of employment opportunities, among other things, may be stored in the server 202.

The server 202 may store user information and other related information, as discussed in detail below. The server 202 may include a Structured Query Language (SQL) such as PostgreSQL or MySQL or a not only SQL (NoSQL) database such as MongoDB, or Graph Databases, etc.

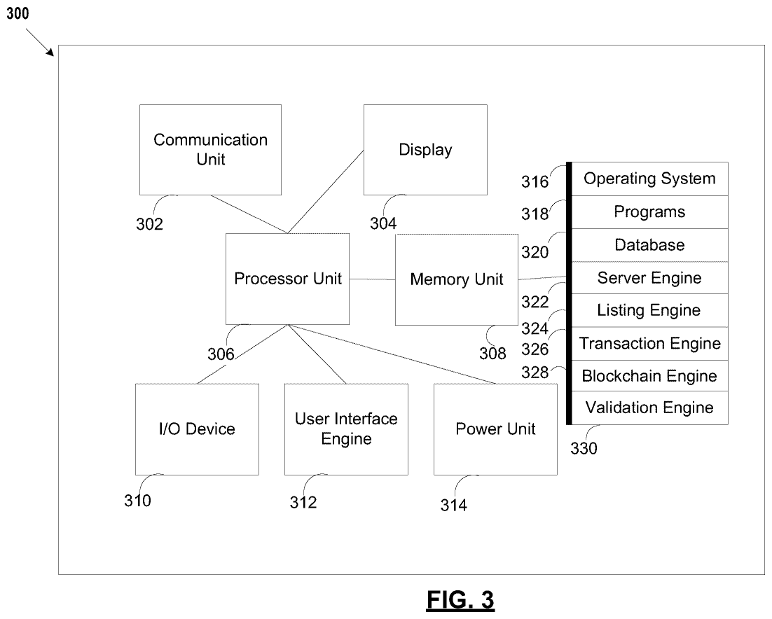

Reference is next made to FIG. 3, which shows a device diagram of a server 300, such as server 202 from FIG. 2, according to an example. The server 300 includes a processor unit 306, a communication unit 302, a memory unit 308, an I/O unit 310, a user interface engine 312, and a power unit 314. The server 300 may have a display 304, which may also be a user input device such as a touchscreen.

The processor unit 306 controls the operation of the server 300. The processor unit 306 can be any suitable processor, controller or digital signal processor that can provide sufficient processing power depending on the configuration, purposes and requirements of the server 300 as is known by those skilled in the art. For example, the processor unit 306 may be a high-performance general processor. In alternative embodiments, the processor unit 306 can include more than one processor with each processor being configured to perform different dedicated tasks. In alternative embodiments, it may be possible to use specialized hardware to provide some of the functions provided by the processor unit 306. For example, the processor unit 306 may include a standard processor, such as an Intel® processor, an AMD® processor or a microcontroller.

The communication unit 302 can include wired or wireless connection capabilities. The communication unit 302 can include a radio that communicates utilizing IEEE 802.11a, 802.11b, 802.11g, or 802.11n, etc. The communication unit 302 can be used by the server 300 to communicate with other devices or computers. The communication unit 302 may be a wired or a wireless network connection.

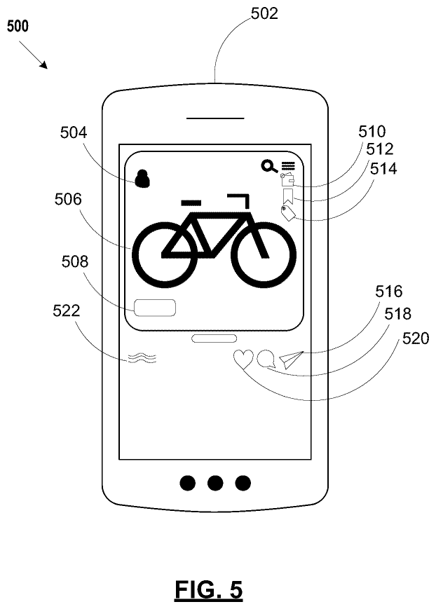

The processor unit 306 can also execute a user interface engine 312 that is used to generate various user interfaces, some examples of which are shown and described herein, such as the interfaces shown in FIGS. 5, 6 and 7.

The user interface engine 312 is configured to generate user interfaces for users to list items for sale, view items for purchase, receive payment for selling items, or other types of interfaces. The various interfaces generated by the user interface engine 312 may be transmitted to a user computing device via communication unit 302. The user interface engine 312 may provide web-based access for users at user computing devices, or additionally may provide one or more APIs for interaction with the server 300.

The display 304 may be an LED or LCD based display.

The memory unit 308 comprises software code for implementing an operating system 316, programs 318, a database 320, server engine 322, listing engine 324, transaction engine 326, blockchain engine 328, and validation engine 330.

The memory unit 308 can include RAM, ROM, one or more hard drives, one or more flash drives or some other suitable data storage elements such as disk drives, etc. The memory unit 308 is used to store an operating system 316 and programs 318 as is commonly known by those skilled in the art. For instance, the operating system 316 provides various basic operational processes for the user device 300. For example, the operating system 316 may be a mobile operating system such as Microsoft® Windows Server® or Ubuntu® Linux® operating system, or another operating system.

The I/O unit 310 can include at least one of a mouse, a keyboard, a touch screen, a thumbwheel, a trackpad, a track-ball, a card-reader, voice recognition software and the like again depending on the particular implementation of the user device 300. In some cases, some of these components can be integrated with one another.

The power unit 314 can be any suitable power source that provides power to the user device 300 such as a power adaptor or a rechargeable battery pack depending on the implementation of the user computing device 300 as is known by those skilled in the art.

The operating system 316 provides various basic operational processes for the operation of the item management platform 200. For example, the operating system 322 may be a Microsoft® Windows Server® operating system, or a Linux®-based operating system, Unix® or macOS® Apple IOS or Google Android, or another operating system. In an alternate embodiment, the operating system 322 may be one such as Microsoft® Windows operating system, a Linux®-based operating system, Unix®, or macOS®

The programs 318 include various user programs so that a server 300 may perform various functions as required for server 300.

The database 320 may be provided at the server 300, or alternatively may be in network communication with the server 300. Where databases are provided by a server, then the user devices may access listings or listing information as required via an Application Programming Interface (API) using communication unit 302.

The database 320 may be configured to define and store information, such as user information, user profile information, item information, wallet information, banking information, blockchain information, or other information related to the listing and sale of an item in the system. The database 320 may be provided at server 300, or alternatively, may be hosted separately but in network communication with server 300.

The server engine 322 may be configured to operate an API or provide a web application accessible through communication unit 302. This can include parsing output from the listing engine 324, transaction engine 326, blockchain engine 328, and validation engine 330. This can include applying business logic as required to provide for the stores and associated functionality. The server engine 322 may send and receive requests to the user computing device, one or more blockchains (e.g., blockchain 208 in FIG. 2), a digital asset management system (such as IPFS), etc.

The listing engine 324 may create, read, update, and delete various item listing records in database 320. This may include creating vouchers corresponding to items that can be stored in the database 320. The listing engine 324 may provide for the listing data for stores that are provided by the platform. This can include providing a listing of items for each store so that the server engine 322 and the user interface engine 312 can prepare user interfaces for users on the stores.

The listing engine 324 may associated a smart contract with the voucher for execution when the item is purchased. The listing engine 324 may associate a stream structure with the voucher based on the selections of the user who creates the item listing.

The transaction engine 326 may be configured to process purchase transactions received at server engine 322. This purchase transaction processing may include obtaining information from the database 320 including the voucher associated with the item being purchased. This may further include sending and receiving information to the blockchain engine 328 in order to mint an NFT associated with an item. This may further include sending and receiving to the blockchain engine 328 to transact with an existing NFT, i.e., where the item is already represented by an NFT on the blockchain.

The transaction engine 326 may cooperate with a blockchain engine 328 in order to perform cryptocurrency transactions, mint NFTs associated with vouchers, or to engage smart contracts.

The blockchain engine 328 may interact with one or more blockchains (see e.g., blockchain 208 in FIG. 2). The sending of calls to the smart contracts on the blockchain may enable payments and the transfer or NFTs associated with items in the system. The blockchain engine 328 may further operate as a cryptocurrency exchange, including allowing users to purchase cryptocurrencies by providing credit card information, bank account numbers, transit numbers, institution numbers, or any other banking information required to complete transactions between fiat currency and cryptocurrency.

The validation engine 330 may function to provide for item validation once an item is received by a purchasing user.

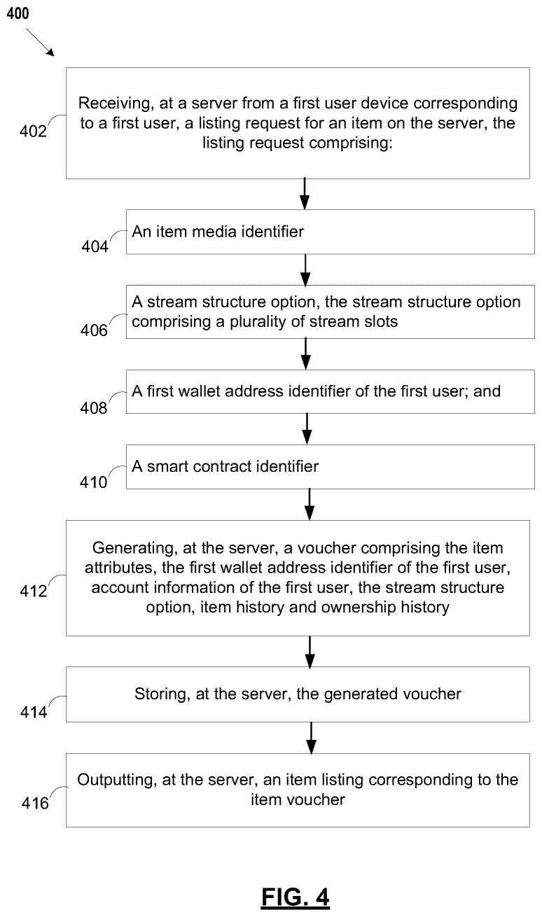

Reference is next made to FIG. 4, which shows a method diagram 400 in accordance with one or more embodiments.

A first listing user may access the platform and create a listing request for an item they wish to sell. For example, referring briefly to FIG. 1, a first user 106 may send a listing request to the store 114 for item 120.

At 402, a server receives from a first user device corresponding to a first user, a listing request for an item on the server, the listing request comprising:

At 404, an item media identifier,

At 406, a stream structure option, the stream structure option comprising a plurality of stream slots,

At 408, a first wallet address identifier of the first user, and

At 410, a smart contract identifier.

The listing request may be an API call to the server, or an HTTP request to the server engine (e.g., server engine 322 in FIG. 3). The listing request may include a request to create a store for adding the item listing. The listing request may include different identifiers and item listing metadata.

The listing request may include an item media identifier that may be, for example, a Uniform Resource Indicator (URI) to a digital asset associated with the item listing. For example, this may include a picture of the item for sale. For digital assets, for example, the item media identifier may include a link to the actual digital asset. The item media identifier may include a link to a digital asset system (see e.g. digital asset system 122 in FIG. 1), including an IPFS system.

The stream structure option may include a reference, including a blockchain address of a stream structure type associated with the item listing. The particular types of stream structures may be described in more detail in FIG. 7.

The first wallet address identifier may correspond to a wallet of the first user. It may be used to authenticate the ownership of the item listing, for payment of gas fees, and to receive payment after purchase.

The smart contract identifier may include an address on a blockchain, an API specification, or a combination thereof that describes the smart contract used to mint an NFT associated with the item listing upon its purchase.

At 412, the server generates a voucher comprising the item attributes, the first wallet address identifier of the first user, account information of the first user, the stream structure option, item history and ownership history. The voucher may be used to render an item listing and may hold the contents of an item listing prior to its first purchase.

At 414, the server stores the generated voucher.

At 416, the server outputs an item listing corresponding to the item voucher.

A second user may access the item listing and decide to purchase the item based on the item listing information. In such a situation, a call is made to a smart contract to mint the NFT associated with the item listing, based on the information in the voucher. When the purchase occurs and the NFT is minted, the stream structure is created, and first user is added.

At this time, when the item is purchased and the purchase request is made to the server, the first user may ship the item to the second user. For example, referring briefly to FIG. 1, the first user 106 may receive notification of the purchase of the item in the item listing from the platform. The first user 106 may ship or transport or otherwise communicate the item to the second user 108. The purchasing user 108 makes a purchase request to the store 114, including an amount of cryptocurrency as payment to the first user 106. The second user 108 may verify the item, and payment may then be released to the first user 106.

Optionally, the server may receive from a second user device corresponding to a second user, a purchase request, the purchase request comprising a second wallet address identifier associated with the second user. The server may create a token associated with the item, the token comprising the item and the voucher. The server may execute a smart contract associated with the smart contract identifier based on the first wallet identifier, the second wallet identifier, and the voucher. The server may generate a stream structure corresponding to the stream structure option. The server may add a first stream entry to the stream structure, the first stream entry comprising a first allocation and the first wallet address identifier of the first user.

The second user may create an item listing to sell the item, which may be purchased by a third user. In such a situation, the item is transferred from the second user to the third user based on the existing NFT. The stream structure is updated to add the second user. Referring briefly to FIG. 1, the second user 108 may transport or ship the item 120 to the third user 112 upon receipt of a notification from the store 114 indicating the sale. The third user 112 may verify the item, and payment may then be release to the second user 108.

Optionally, the method may further include: the server receiving from a third user device corresponding to a third user, a purchase request, the purchase request comprising a third wallet address identifier associated with the third user. The server may update the token associated with the item. The server may execute a smart contract associated with the smart contract identifier based on the first wallet identifier, the second wallet identifier, the third wallet identifier, and the voucher. The server may add a second stream entry to the stream structure, the second stream entry comprising a second allocation and the second wallet address identifier of the second user. The server may execute the stream structure corresponding to the stream structure option, wherein the first user occupies a first slot of the plurality of stream slots.

A fourth user may purchase the item based on an item listing of the third user, which may be shipped from the third user to a fourth user. The stream structure is updated to add the third user, the item is validated, and payment is released to the third user.

Optionally, the method may further include: the server receiving from a fourth user device corresponding to a fourth user, a purchase request, the purchase request comprising a fourth wallet address identifier associated with the fourth user. The server may update at the server, the token associated with the item. The server may execute a smart contract associated with the smart contract identifier based on the first wallet identifier, the second wallet identifier, the third wallet identifier, the fourth wallet identifier, and the voucher. The server may add a third stream entry to the stream structure, the third stream entry comprising a third allocation and the third wallet address identifier of the third user. The server may execute the stream structure corresponding to the stream structure option, wherein the first user occupies a first slot of the plurality of stream slots, and the second user occupies a second slot of the plurality of stream slots.

Optionally, the server may execute the smart contract associated with the smart contract identifier based on at least two wallet identifiers selected from the list of the first wallet identifier, the second wallet identifier, the third wallet identifier, and the fourth wallet identifier; and the voucher generates an entry on a blockchain, wherein the entry on the blockchain is a blockchain entry.

Optionally, the blockchain may be selected from Etherium, Bitcoin, Tether, Binance Coin, USD Coin, XRP, Terra, Solana, Cardano, and Avalanche.

Optionally, the token associated with the item may be updated to reflect the purchase request.

Optionally, the number of stream structure slots may be a finite number.

Optionally, one of the slots of the plurality of stream structure slots may comprise the first user.

Optionally, subsequent users may be added to the stream structure using a first in first out structure.

Verification or validation may be performed by the platform subsequent to the purchase request such that the purchase price is held until the receiving user verifies or validates the item. This can include comparing an item characteristic to identify the item as original. The verification or validation may occur after each purchase request, so that the purchasing user may have certainty about the provenance and quality of the item they are purchasing.

Optionally, the voucher may further comprise a verified identifier, wherein the verified identifier is a characteristic to accurately identify the item as original, a serial number, a third-party validation, a certificate of authenticity and any combination thereof.

Optionally, executing the smart contract may include a withdrawal request from the first wallet identifier, the second wallet identifier or the third wallet identifier.

Optionally, the method may further include: the server sending a verification request to the second user, the second user, in response to the verification request, may send a verification response comprising confirmation information, to the server. The server may output a verification result, in response to the verification response, based on the item attribute and verification response; wherein the verification result may compare the item attribute to the verification response.

Optionally, subsequent to the verification result the server may trigger a payment request from the second wallet identifier to the first wallet identifier.

Optionally, the payment may be held by the server until the withdrawal request is received at the server, from a user.

Optionally, the stream structure option may include an unlimited number of stream slots.

Optionally, the stream structure option may include four stream slots.

Optionally, the users identified in each of the four stream slots may receive an equal payment.

Optionally, the users identified in each of the four stream slots may receive unequal payments.

Optionally, the method may further include generating, at the server, a store, the store comprising a store smart contract.

Optionally, the store may be generated based upon a first user identifier, an item listing identifier; and a stream structure identifier.=

Optionally, the finite stream structure slots may include five slots.

Optionally, the users identified in each of the five slots may receive an equal payment.

Optionally, the users identified in each of the five slots may receive unequal payments.

Optionally, the first listing user may remain in the first slot, while the users identified in each of the remaining stream slots are replaced in a first in first out (FIFO) scheme. Other schemes may be used.

Optionally, the first listing user may remain in the first slot, while users are progressively added to the stream slots.

Optionally, as users are added to the stream slots the payment allocations may shift progressively downwards.

Optionally, the first listing user receives a preferential payment while the users identified in the remaining stream slots receive an equal share.

Optionally, the first listing user receives an equal payment to the users identified in the remaining stream slots.

Optionally, the token may be generated upon completion of the purchase request, and the method may further include: executing the smart contract, wherein the smart contract retrieves, from the server, the information contained in the store smart contract; minting the token; and assigning the token to a purchasing user, wherein the ownership may be assigned to the second wallet identifier of the second user.

Optionally, the generating the stream structure may correspond to the stream structure option triggering the smart contract to add a new user to the stream structure slots.

Optionally, the payment may be allocated based on the parameters of the store smart contract.

Optionally, the parameters of the store smart contract may provide for payment to a plurality of wallet identifiers of a plurality of users.

Optionally, the method may further include adding the first stream entry to the stream structure, the first stream entry comprising the first allocation and the first wallet address identifier of the first user.

Optionally, the method may further include adding the second stream entry to the stream structure, the second stream entry comprising the second allocation and the second wallet address identifier of the first user.

Optionally, a subsequent buyer may be added to the plurality of stream slots following execution of the smart contract.

Optionally, the execution of the smart contract may further include a change of ownership recorded on the token.

Optionally, the payment may be held in proxy until a release of funds condition is satisfied.

Optionally, the release of funds condition may include at least one of physical transfer of the item, completion of the verification request and when the withdrawal request is received at the server.

Referring next to FIG. 5, there is shown an example of a user interface 500 for interaction and notification in accordance with one or more embodiments.

A user operates the user interface 502. The user interface 502 may show an image of an item 506 listed on the item management platform as described in FIG. 1. The user interface 500 may display the user listing the item 504, an image associated with the item for sale 506 and the price of the item 508. The user may interact with the item listing 520 on the user interface 502 by liking 520, commenting 518 or sending 516 the item listing 520 to another user. The user interactions, including the like 520, comments 518, and item shares 516 may be stored in association with the user profile, the item listing, or both, in the database.

The image of the item 506 may be stored in the digital asset system, for example, an IPFS image may be used. There may be one or more images associated with the item listing.

A like 520, may be permanently associated with an item. This association may continue after an item transfer between users. An item 506 can only be liked 520 once per user. A user may remove a like 520 from an item 504.

A comment 518, may be permanently associated with an item. A user may comment 518 multiple times on an item listing 506 and comment 518 on other users' comments, for example in a common discussion thread format.

A user who owns the item listing 506 may receive notification of new comments 518 and/or new likes 520.

The user interface 520 may also include a wallet 510, a flag 512 and a tag 514.

The tag 514 may be used to categorize, describe and sort items. A tag 514 may provide a mechanism for a user to associate items with a criterion that can be searched. The tag 514 may be a stable tag, public tag and/or private tag.

A stable tag may be created by the server for common usage and are consistent with established item categories. A stable tag may improve searching functionality and optimize metrics.

A public tag may be created by a user and may be visible and searchable by other users. A public tag may be less formal than a stable tag, and may identify for example social trends, and pop culture terminology, seller-specific terminology and other descriptive terms that do not fall under established categories.

A private tag may be created by a user and may not be visible and searchable by other users. A private tag may allow a user to organize their collection to facilitate searching and/or sorting. A user may use any type of naming convention in creating a private tag.

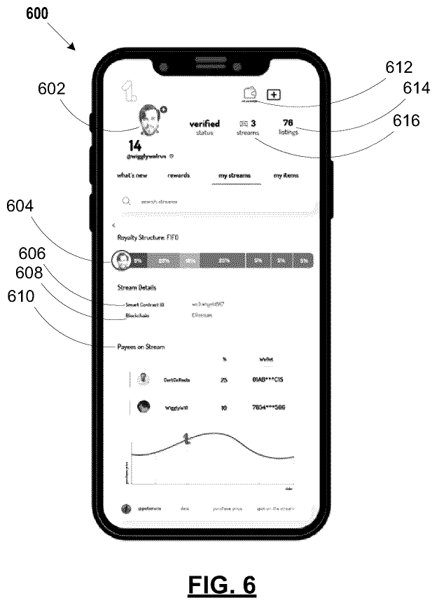

Referring next to FIG. 6, there is shown another example of a user interface 600 for interaction and notification in accordance with one or more embodiments.

The user can access their user profile 602. The user may view their wallet 612, listings 614 and streams 616.

The details of the streams 616 may be viewed in further detail on the user interface 600. The user may view the royalty structure 604, which is describe in further detail in FIG. 7, the stream details, including the smart contract ID 606 and blockchain 608. The payees on the stream 610 may also be viewed on the user interface 600.

The blockchain 608 may include Etherium, Bitcoin, Tether, Binance Coin, USD Coin, XRP, Terra, Solana, Cardano, Avalanche or any other suitable blockchain.

Referring next to FIG. 7, there is a stream structure diagram 700 showing various examples of different stream structures.

A stream may be a compensation structure that may be applied to an item throughout the lifecycle of its existence on a blockchain. The more stream slots a user occupies, the more potential profit the user may receive. By enabling users to create item listings with stream structures associated participation in the community associated with the item listing may be increased, and more individuals to bring their valued items onto the platform. The ability to create these streams may be referred to as a Layered Royalty Payment Structure (LRPS). These structures may dictate the payouts associated with each stream. Some of these structures may operate continuously in nature while others will be limited to a finite number of transactions.

The original owner of an item who introduces it to the platform may be known as the First Listed User (FLU). The FLU may have the privilege to create and configure their item's stream attributes. As the item is listed and transacted in the future, users who occupy stream slots may be notified when new stream income has been attributed to them via their user account. To help reduce fees (such as gas fees) associated with transferring cryptocurrency between wallets on the blockchain, users may select when they would like to withdraw funds to their connected wallets.

The funds may be held in meanwhile in a treasury governed via smart contract, thus ensuring that the minimal fees (such as gas fees) accrue to the end-user. Streams may be visible in a user account profile whether they are active or expired so that full transparency and chain of custody may be established.

While traditional NFTs allow for the creator of the NFT to receive royalties on all subsequent transactions of their creations, an NFT created herein with an associated stream structure may permit royalties to be paid to future holders of said NFT dependent on the type of structure applied at the minting of the item. Users may also sell their item without the worry of a loss of future benefits from increases in desirability and value associated with the item. This may mitigate the fear of missing out on profits that many content or item owners struggle with in the conventional marketplace, and which discourages them from selling items.

The LRPS model may thus be viewed as a hedge against poor market timing. One of the main things that LRPS offers in this way is providing an incentive to the user to continue to use the platform to resell their items, instead of leaving the platform for a competing platform. An individual may thus be given a “bonus” for introducing an item within the platform by having the right to assign a stream structure to a smart contract assigned to the NFT. Each structure may be designed to ensure that every individual that lists a new unique item to the platform is incentivized more than others that partake in the stream. This incentive may motivate users to list their items onto the platform, including cementing their position at the top of the stream. First listing users who do decide to sell their items can be provided passive income from the future sales of the items.

The stream structures shown include a first stream structure 702, a second stream structure 706, and a third stream structure 710. Each stream structure type may be identified by a stream structure identifier that may uniquely identify the stream structure. The stream structure compositions may be configurable by a user, and the user interfaces provided may include interfaces for creating and editing new structures.

Each stream structure may have one or more stream slots and a first listed user. For example, stream 702 may include stream slots such as first slot 704a, second slot 704b, third slot 704c, fourth slot 704d, and a fifth slot 704e. While five slots are shown in stream 702, it is understood that there may be 2, 3, 4, 5, 6, 7, 8, 9, or 10 or more slots. There may be an unlimited number of slots.

Each stream structure interface may display information associated with a stream structure. For example, the stream structure interface may include a first listing user avatar 704f, and a slot interface showing geometrically the share (i.e. the allocation) of each of the stream slots 704a-704e. The first stream slot 704a is shown with an allocation of 40%. The second stream slot 704b is shown with an allocation of 30%. The third stream slot 704c is shown with an allocation of 10%. The fourth stream slot 704d is shown with an allocation of 10%. A fifth stream slot 704e is shown with an allocation of 10%.

The plurality of stream slots may be finite or infinite. The plurality of stream slots may have a predetermined number or may be variable as new users are added.

The replacement of users within a stream structure may be performed using a first in first out (FIFO) scheme. Other schemes may be used. For example, the first listing user may remain in the first slot 704a and not be replaced, where the second slot 704b, third slot 704c, fourth slot 704d, and fifth slot 704e may be replaced. Instead of replacement, the allocation may shift progressively downwards as new users are added in newly added slots.

Stream 702 may be an example of the FIFO early return structure. The stream structure may contain five finite stream slots. The first user may receive a 40% royalty, the second user may receive a 30% royalty, the third, fourth and fifth users may each receive a 10% royalty for each sale.

At 706, there is shown a stream structure example having a FIFO even steven structure. The royalty payout is the same regardless of the position of the user within a slot within the stream structure. The listing user may receive a 40% royalty, while the second, third, fourth and fifth users may receive a 15% royalty.

At 710, an example of a FIFO bookends stream structure is shown. The royalty payments of the bookends are highest at the start and end of the stream. The second and fifth users receive a 25% royalty. The third and fourth users receive a 5% royalty.

In an embodiment, the first user is the item listing user and always receives a 40% royalty and remains on the stream structure.

In an embodiment, the first user is removed from the stream of a FIFO structure after the fifth transaction.

The present invention has been described herein by way of example only. Various modification and variations may be made to these exemplary embodiments without departing from the spirit and scope of the invention, which is limited only by the appended claims.

We claim:

1. A computer-implemented method for structured blockchain streams, the method comprising:
receiving, at a server from a first user device corresponding to a first user, a listing request for an item on the server, the listing request comprising:
an item media identifier,
a stream structure option, the stream structure option comprising a plurality of stream slots;
a first wallet address identifier of the first user; and
a smart contract identifier;
generating, at the server, a voucher comprising the item attributes, the first wallet address identifier of the first user, account information of the first user, the stream structure option, item history and ownership history;
storing, at the server, the generated voucher; and
outputting, at the server, an item listing corresponding to the item voucher.

2. The method of claim 1, further comprising:
receiving, at the server from an second user device corresponding to a second user, a purchase request, the purchase request comprising a second wallet address identifier associated with the second user;
creating, at the server, a token associated with the item, the token comprising the item and the voucher;
executing a smart contract associated with the smart contract identifier based on the first wallet identifier, the second wallet identifier, and the voucher;
generating a stream structure corresponding to the stream structure option;
adding a first stream entry to the stream structure, the first stream entry comprising a first allocation and the first wallet address identifier of the first user.

3. The method of claim 2, wherein executing the smart contract associated with the smart contract identifier based on at least two wallet identifiers selected from the list of the first wallet identifier, the second wallet identifier, a third wallet identifier, and a fourth wallet identifier; the voucher generates an entry on a blockchain, wherein the entry on the blockchain is a blockchain entry; and the token associated with the item is updated to reflect the purchase request.

4. The method of claim 3, wherein the blockchain is selected from the group of Etherium, Bitcoin, Tether, Binance Coin, USD Coin, XRP, Terra, Solana, Cardano, and Avalanche.

5. The method of claim 1, wherein:
the number of stream structure slots is finite; preferably the stream structure option comprises four stream slots; more preferably the streams structure option comprises five streams slots; and optionally subsequent users are added to the stream structure using a first in first out structure.

6. The method of claim 1, wherein a user identifier corresponding to the first user is stored in one of the slots of the plurality of stream structure slots.

7. The method of claim 1, wherein the voucher further comprises a verified identifier, wherein the verified identifier is a characteristic to accurately identify the item as original, optionally a serial number, a third party validation, a certificate of authenticity and any combination thereof.

8. The method of claim 2, wherein executing the smart contract comprises a withdrawal request from the first wallet identifier, the second wallet identifier or a third wallet identifier.

9. The method of claim 2, further comprising:
the server, sending a verification request to the second user;
the second user, in response to the verification request, sends a verification response comprising confirmation information, to the server;
the server, outputs a verification result, in response to the verification response, based on the item attribute and verification response; wherein the verification result compares the item attribute to the verification response.

10. The method of claim 9, wherein subsequent to the verification result the server triggers a payment request from the second wallet identifier to the first wallet identifier.

11. The method of claim 10, wherein the payment is held by the server until the withdrawal request is received at the server, from a user, preferably wherein the payment is held in proxy until a release of funds condition is satisfied.

12. The method of claim 5, wherein the four stream slots are configured to generate payments equally amongst users or unequally amongst users.

13. The method of claim 1, further comprising generating, at the server, a store, the store comprising a store smart contract, the store comprising:
a first user identifier
members of the store, wherein the members of the store have a user-specific wallet identifier;
an item listing identifier; and
parameters of the stream structure option.

14. The method of claim 2, wherein the token is generated upon completion of the purchase request, further comprising:
executing the smart contract, wherein the smart contract retrieves, from the server, the information contained in the store smart contract;
minting the token;
assigning the token to a purchasing user, wherein the ownership is assigned to the second wallet identifier of the second user.

15. The method of claim 2, wherein generating the stream structure corresponding to the stream structure option triggers the smart contract to add a new user to the stream structure slots.

16. The method of claim 5, wherein the payment is allocated based on the parameters of the store smart contract, optionally wherein the parameters of the store smart contract provide for payment to a plurality of wallet identifiers of a plurality of users.

17. The method of claim 2, further comprising:
adding the first stream entry to the stream structure, the first stream entry comprising the first allocation and the first wallet address identifier of the first user; wherein the first stream entry is added to the stream structure before or after the purchase request from the second user device; and optionally
adding the second stream entry to the stream structure, the second stream entry comprising the second allocation and the subsequent wallet address identifier of the second user.

18. The method of claim 2, wherein a subsequent buyer is added to the plurality of stream slots following execution of the smart contract, and optionally wherein the execution of the smart contract further comprises a change of ownership recorded on the token.

19. The method of claim 11, wherein the release of funds condition includes at least one of physical transfer of the item, completion of the verification request and the withdrawal request is received at the server.

20. A computer-implemented system for structured blockchain streams, comprising:
a memory;
a network device;
a processor in communication with the memory and the network device, the processor configured:
receive, at a server from a user device corresponding to a user, a listing request for an item on the server
generate, at the server, a voucher comprising the item attributes, a wallet address identifier of the user, account information of the user, a stream structure option, item history and ownership history;
store, at the server, the generated voucher; and
output, at the server, an item listing corresponding to the item voucher.
